(19) United States
(12) Patent Application Publication
(10) Pub. No.: US 2024/0006885 A1
(43) Pub. Date: Jan. 4, 2024

(54) ENERGY STORAGE SYSTEM WITH RESISTOR CIRCUIT FOR BI-DIRECTIONAL HIGH-POWER APPLICATIONS

(71) Applicant: Hitachi Energy Switzerland AG, Baden (CH)

(72) Inventors: Lexuan MENG, Västerås (SE); Haofeng BAI, Västerås (SE); Tong WU, Västerås (SE); Mohsen ASOODAR, Solna (SE); Jean-Philippe HASLER, Västerås (SE); Gunnar INGESTRÖM, Västerås (SE); Jan KHEIR, Västerås (SE); Jan SVENSSON, Västerås (SE)

(21) Appl. No.: 18/036,387

(22) PCT Filed: Nov. 11, 2020
(86) PCT No.: PCT/EP2020/081703

§ 371 Date: May 10, 2023

(51) Int. Cl. H02J 3/32; H02J 7/00; H02J 7/06

(52) U.S. Cl. CPC H02J 3/32; H02J 7/00302; H02J 7/06; H02J 7/0048

(57) ABSTRACT

An energy storage system and a method for controlling such a system is disclosed. The energy storage system comprises a plurality of interconnected energy storage cells forming an energy storage module, a power converter connected to the energy storage module, a resistor circuit connected in parallel to the energy storage module, a switch connected in series with the resistor circuit and configured to disconnect the resistor circuit from the energy storage module, and a control unit operably connected to the switch. The control unit is configured to receive information pertaining to a transmission of energy in the energy storage system and to control the switch based on said information.

### FIELD OF THE INVENTION

The present invention relates to the field of electric power transmission systems, and in particular to energy storages for use in such power systems.

### BACKGROUND OF THE INVENTION

Electric power systems need to provide electric power in a reliable fashion. Therefore, such technologies often comprise energy storage systems for evening out frequency fluctuations, shortages and the like. Preferably, the energy storage systems may store energy during off-peak periods and discharge energy to the electrical grid during on-peak periods, for example to provide fast frequency response and inertia response.

An example of such energy storage systems comprises an energy storage bank having a number of series- and/or parallel-connected battery cells or supercapacitors arranged in modules. The modules may be series-connected to form energy storage strings. Several such strings may be connected to a converter system, which may operate in a bidirectional manner for outputting the discharged energy to an AC power transmission system and charging the battery cells from the same.

The energy storage systems may thus be successfully employed for balancing and smoothing demand and power swings on the electrical grid. However, this requires operation at relatively high power levels, wherein the energy storage system for example may be required to absorb and discharge relatively large amounts of energy during a relatively short period of time. At the same time the system should ensure that the individual battery cells are kept at safe voltage levels during operation. Satisfying the capacity requirements for such a bidirectional use has turned out to be rather costly, requiring relatively large energy storage systems.

### SUMMARY OF THE INVENTION

Thus, it would be advantageous to achieve an energy storage technology overcoming or at least alleviating the above-mentioned drawbacks. In particular, it would be desirable to provide improved means for stabilising and increasing quality of power transmission systems.

These objects, among others, are achieved by an energy storage system and a method as claimed in the appended independent claims.

Hence, according to a first aspect an energy storage system is provided, which is configured to be connected to an alternating current, AC, power transmission system. The energy storage system comprises a plurality of interconnected energy storage cells forming an energy storage module, and a power converter connected to the energy storage module. The power converter is configured to output power from the energy storage module to the AC power transmission system and to charge the energy storage module with power from the AC power transmission system. Further, the energy storage system comprises a resistor circuit connected in parallel to the energy storage module, a switch connected in series with the resistor circuit and configured to disconnect the resistor circuit from the energy storage module, and a control unit that is operably connected to the switch. The control unit is configured to receive information pertaining to a transmission of energy in the energy storage system and to control the switch based on the received information.

According to a second aspect, a method for controlling an energy storage system according to the first aspect is provided. The method comprises receiving information pertaining to the transmission of energy in the energy storage system, and controlling the switch based on the received information.

During operation the energy storage system may be required to absorb relatively large amounts of energy during relatively short periods of time. This may for example be the case when the energy storage system is used for frequency regulation, wherein the energy storage system injects or absorbs power to the grid to maintain and regulate the grid power. Usually this requires a relatively large power capacity of the energy storage system in order to allow relatively large amounts of energy to be absorbed in relatively short periods of time. Conventionally, this may be achieved by choosing high charge and discharge rate (C-rate) energy storage, or by increasing the number of energy storage cells such that the absorbed energy can be distributed over a larger number of cells.

The resistor circuit according to the present invention provides an alternative solution, in which peaks in absorbed energy may be absorbed or “burned” by the resistor circuit. In this way the high storage capacity requirements set for the energy storage cells may be relieved and the sizing and C-rate of the overall energy storage system reduced. Thus, by connecting the resistor circuit to the energy storage module of the system, the system may be capable of absorbing increased power levels without increasing its storage capacity and while maintaining the energy storage cells within safe voltage levels. Further, the resistor circuit can be employed to discharge energy from the energy storage module as a fast way to limit or balance the voltage over the energy storage module and to keep the voltage at a safe level.

The control unit is used for controlling the switch connecting and disconnecting the resistor circuit from the energy storage module. The switch may be opened/closed based on information pertaining to a transmission of energy in the energy storage system, which allows for the resistor circuit to consume at least some of the energy that is input to the energy storage system, depending on certain operational requirements that will be discussed in further detail below.

According to an embodiment the control unit may be configured to control the switch to disconnect the resistor circuit from the energy storage module in case energy is output from the energy storage module. This allows for the energy stored in the energy storage module to be discharged from the energy storage module and transmitted to the power converter.

In an embodiment the control unit may be configured to control the switch to connect the resistor circuit to the energy storage module in case energy is transmitted to the energy storage module. By connecting the resistor circuit to the energy storage module, the resistor circuit may consume or burn at least some of the energy transmitted to the energy storage module. Preferably, the resistor circuit may be used for lowering the voltage over the energy storage module and for enabling the energy storage system to absorb more power than otherwise would have been possible given the capacity of the energy storage module. In other words, the resistor circuit may be employed to increase the energy absorption capacity of the energy storage system.

In an embodiment the control unit may be configured to control the switch to connect the resistor circuit to the energy storage module in case energy transmitted to the energy storage module exceeds a predetermined power threshold. The resistor circuit may hence be employed to handle peaks in the power transmitted to the energy storage module and thus help protecting the energy storage module from being overloaded.

According to an embodiment the control unit may be configured to control the switch to connect the resistor circuit to the energy storage module in case a level of energy stored in the energy storage module exceeds a predetermined storage threshold. In this way the resistor circuit may absorb transmitted energy in case the remaining storage capacity of the energy storage module is limited or if the energy storage module is fully charged.

According to an embodiment the energy storage system may further comprise an additional switch connected in series with the energy storage module and operably connected to the control unit. The additional switch, which also may be referred to as a disconnector, may be configured to disconnect the energy storage module from the power supply, i.e., from the power converter, and further to allow the resistor circuit to operate stand-alone without being connected to the energy storage module.

According to an embodiment, the control unit may be configured to control the additional switch to disconnect the energy storage module from the power converter in case energy is (or is to be) transmitted to the energy storage module and a level of energy stored in the energy storage module exceeds a predetermined storage threshold. The disconnector hence allows for the energy storage module to be disconnected in case its remaining storage capacity is limited or if the energy storage module is fully charged. This is a way to ensure that the energy storage system may still be capable of absorbing energy even if the energy storage module is fully charged.

In an embodiment, the energy storage system may comprise a plurality of energy storage modules and the resistor circuit be connected in parallel to the plurality of energy storage modules. The energy storage modules may be connected in series and/or in parallel to each other, for example depending on the desired voltage to be achieved and connected in parallel with one or several resistor circuits.

In an embodiment, a plurality of series connected energy storage modules may form an energy storage string, wherein the resistor circuit is connected in parallel to the energy storage string.

It is to be noted that various configurations and combinations of energy storage modules and resistor circuit(s) are conceivable within the scope of the claims, and a few detailed examples will also be discussed in connection with the appended drawings.

According to an embodiment, the energy storage module and the resistor circuit may be structurally arranged in a common physical entity. From this may be understood that the resistor circuit may form part of or be integrated or collocated with the energy storage module. The present arrangement may be contrasted to other configurations in which the resistor circuit is provided at a distance from the energy storage module, such as at a different physical location or in a structure that is separate and distinct from the structure in which the energy storage module is arranged.

In the context of the present disclosure, “energy storage system” may generally refer to energy storage solutions for storing electrical energy and supplying it to designated loads as a primary or supplementary source, and for voltage and frequency regulation. Preferably, the energy storage system is dimensioned for medium voltage to high voltage DC.

By “AC power transmission system” is generally meant a structure for transmission and/or distribution of electric power. The AC power transmission system may in some examples be referred to as an electric power transmission network, a transmission network, a power grid, or a grid.

By the term “energy storage cell” may generally be understood a device capable of accepting electric energy, storing electric energy and releasing electric energy. Thus, the energy storage cell may refer to a device that is capable of repeatedly being (re)charged. Examples of such devices include supercapacitors, flywheels and batteries.

The energy storage cells may be interconnected, preferably in series, in a stack configuration, to form an energy storage module. A group of interconnected energy storage modules may be referred to as an energy storage string, and a plurality of strings may be grouped into an energy storage bank.

By the term “power converter” is generally meant a device for converting electric energy between AC and DC. The power converter, which also may be referred to as an inverter, may be configured to change AC power to DC to charge the energy storage module, and the DC power from the energy storage module into single of multi-phase AC energy at a frequency decided by the user requirements. Thus, the power converter may be referred to as a bidirectional converter.

The term “resistor circuit” may refer to a passive or active electrical component that is capable of dissipating at least some of the electrical power as heat. In some examples, the resistor circuit may be referred to as a power resistor.

The resistor circuit may be provided on an energy storage module level, i.e., connected to one or several energy storage modules. However, the resistor circuit may also be provided on an energy storage cell level, wherein the resistor circuit is connected to an individual cell rather than to a module of a plurality of cells. For this purpose, the energy storage module may in some embodiments be considered to include only one energy storage cell.

A “switch” may, in the context of the present application, be realised as an electrical component that is capable of disconnecting and connecting the resistor circuit and/or the energy storage module from power supply. When arranged in its disconnecting state the switch may be referred to as being “open”, whereas it in its connecting state may be referred to as being “closed”. Preferably, the operation of the switch is controlled by the control unit, which may send a control signal to the switch which, when the signal is received at the switch, may cause the switch to change between the open and the closed state and vice versa. The switch may in some examples be structurally integrated with the resistor circuit, which term hence may include also the switch.

The switch may preferably be a semiconductor switch, such as a MOSFET or an IGBT. The MOSFET switch may be suitable for voltages up to 1000 Volts, whereas the IGBT switch may be suitable for voltage levels above 200 Volts.

The control unit, or controller, may be understood as a device that is capable of receiving information pertaining to a condition, state or operation of the energy storage system, and outputting instructions for controlling the operation of components of the energy storage system. In particular, the control unit may be capable of controlling the operation of the switch(es), but also the power converter and further components included in the energy storage system. The control unit may be structurally integrated in the energy storage system or arranged physically remote from the system.

The control unit may thus be configured to issue control instructions based on received information. The received information may relate to an actual state or condition of the system, such as actual transmission of energy to/from the energy storage module or actual absorption of energy. However, the received information may also refer to a desired state or condition of the system, such as a desired absorption or discharge of energy. The information may thus relate to (actual or desired) charging, discharging or absorption of electrical energy in the energy storage system as a whole, at the level of an individual energy storage module, or at the level of an individual energy storage cell.

The invention may be embodied as computer-readable instructions for controlling a programmable computer in such manner that it performs the method outlined above. Such instructions may be distributed in the form of a computer-program product comprising a computer-readable medium storing the instructions. In particular, the instructions may be loaded in a control unit responsible for controlling components of the energy storage system, such as for example the switch.

It is noted that embodiments of the invention relate to all possible combinations of features recited in the claims. Further, it will be appreciated that the various embodiments described for the energy storage system according to the first aspect are all combinable with embodiments of the method as defined in accordance with the second aspect.

### BRIEF DESCRIPTION OF THE DRAWINGS

These and other aspects will now be described in more detail with reference to the appended drawings showing embodiments.

FIG. 1 illustrates an energy storage system according to an embodiment.

FIG. 2a illustrates a plurality of interconnected energy storage modules and resistor circuits forming an energy storage bank according to an embodiment.

FIG. 2b shows an energy storage module, a resistor circuit and a switch according to an embodiment.

FIGS. 3 and 4 show energy storage modules, resistor circuits and switches according some embodiments.

FIG. 5 is flow chart outlining a method according to an embodiment.

All the figures are schematic, not necessarily to scale and generally only show part which are necessary to elucidate the embodiments, wherein other parts may be omitted or merely suggested. Like reference numerals refer to like elements throughout the description.

### DETAILED DESCRIPTION

The present aspects will now be described more fully hereinafter with reference to the accompanying drawings, in which currently preferred embodiments are shown.

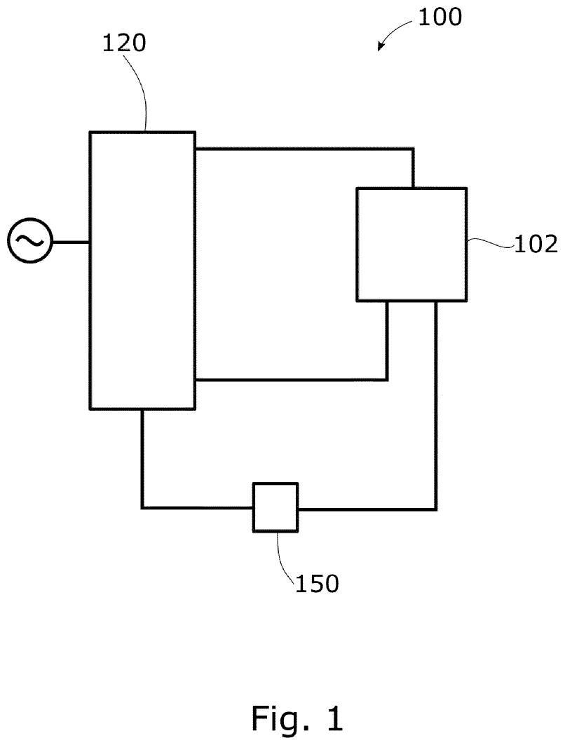

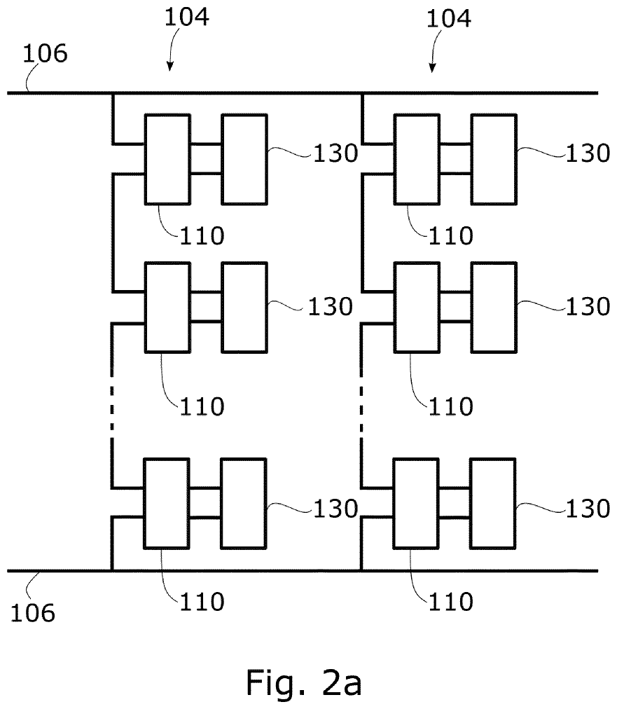

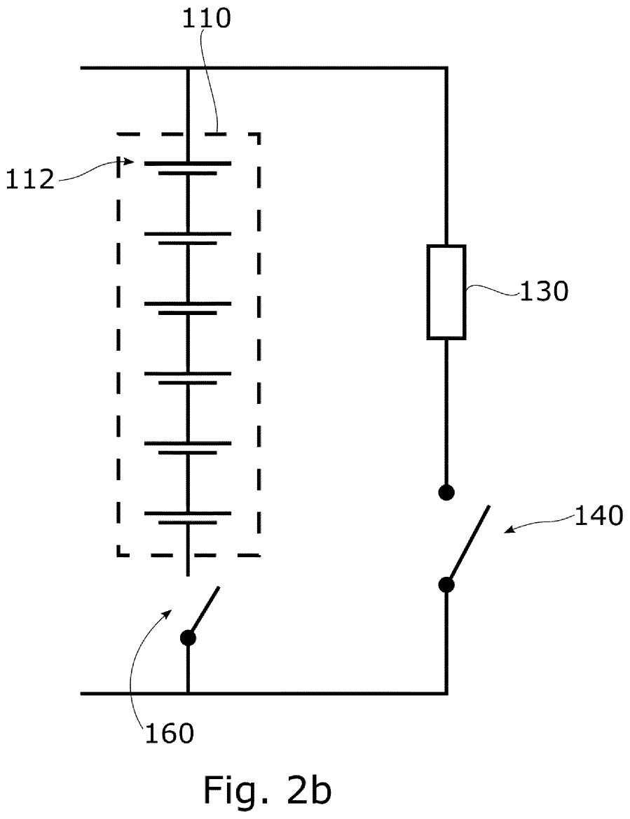

An energy storage system 100 according to an embodiment will be described with reference to FIG. 1, illustrating an energy storage bank 102, a power converter 120 and a control unit 150. The energy storage bank 102 may comprise a plurality of energy storage cells (not shown) and one or several resistor circuits that can be connected to the energy storage cells so as to burn at least some of the energy supplied to the energy storage cells. The arrangement of energy storage cells and resistor circuit(s) will be described in more detail in connection with FIGS. 2-5 below.

The energy storage bank 102 may be charged by electrical energy supplied from the power converter 120 and may further discharge energy to the power converter 120. The converter, in turn, may be connected to an AC power transmission system, also referred to as a grid. Thus, the power converter 120 may be a bidirectional AC/DC converter capable of transmitting power both to and from the energy storage bank 102.

The control unit 150 may be operably connected to the energy storage bank 102 and, preferably, also to the power converter 120, to control the operation of the energy storage system 100. The control unit may preferably receive information indicating a power transmission in the system, such as electrical power charging or discharging the energy storage bank 102, and use the received information to control the charging/discharging of the energy storage cells of the bank 102 and the absorption/discharge of energy of the energy storage system as a whole.

The energy storage system 100 may be incorporated in a distinct physical entity, such as one or several physical enclosures (not shown) that can be transported to a desired site and connected to the AC power transmission system.

FIG. 2a shows a pair of energy storage strings 104, each comprising a plurality of energy storage modules 110. The energy storage modules 110 of each string 104 may be connected in series, whereas the two energy storage strings 104 may be connected in parallel to form an energy storage bank 102 similar to the one described above in connection with FIG. 1. In the present example each storage module 110 may further be connected in parallel to a respective resistor circuit 130, which may be disconnected by means of a switch (not shown in present figure).

During charging energy may be transmitted to the energy storage modules 110 via conductors 106. Preferably, the conductors 106 may be provided as common bus bars connecting the strings 104 to the power converter. In case the power that is transmitted to a particular energy storage module 110 exceeds a predetermined threshold, the resistor circuit 130 may be connected to burn at least some of the energy and thereby reduce the voltage over the energy storage module 110.

The resistor circuit 130 may be disconnected from the energy storage module 110 during discharging so as to avoid that energy is consumed by the resistor circuit 110.

The connection/disconnection of the resistor circuit 130 may for example be enabled by a switching means, which may form a part of, be integrated with or collocated with the resistor circuit 130 or provided as a separate component connected to the resistor circuit 130. Implementation examples of means for connecting/disconnecting the resistor circuit 130 will be discussed in the following

FIG. 2b shows an example of an energy storage module 110 according to an embodiment, which may form part of an energy storage system similar to the one discussed in connection with FIG. 1. The energy storage module 110 may be connected in parallel to a resistor circuit 130, which can be disconnected from the energy storage module 130 by means of a switch 140 connected in series with the resistor circuit 130. Further, an additional switch 160 may be provided to allow the energy storage module 110 to be disconnected from power.

As indicated in the present figure, the energy storage module 110 may comprise a plurality of interconnected energy storage cells 112. In the present example, the energy storage cells 112 may be serially interconnected in a stack configuration, and the number of cells 112 chosen to achieve the desired voltage level. The energy storage cells 112 may for example be battery cells, or other types of rechargeable cells such as capacitors or supercapacitors. Examples of battery cells 112 may include lithium ion batteries, lead acid batteries, nickel cadmium batteries and sodium nickel chloride batteries.

The energy storage module 110 may be connected to an additional switch, or disconnector 160 for selectively connecting the energy storage module 110 to other energy storage modules 110 and/or the power converter (not shown). The disconnector 160 may for example be a semiconductor switch, for example including MOSFET or IGBT devices with anti-series connection, or single MOSFET or IGBT with anti-parallel diode. In an example, the energy storage module 110 may be connected in series with an arrangement 160 comprising an anti-charging diode with a controllable switch for charging, which has the benefits that it allows the voltage of the resistor circuit 130 to be clamped, the charging current to be limited when needed, and over-charging to be avoided. Preferably, the switch 160 may be opened when the energy storage module 110 is fully charged, thereby reducing the risk for over-charging.

As mentioned above, the resistor circuit 130 may be connected in series with a switch or disconnector 140 for selectively connecting the resistor circuit 130 to the energy storage module 110. The switch 140 may for example be a semiconductor switch, such as MOSFET or IGBT devices with anti-series connection, or single MOSFET or IGBT with anti-parallel diode.

The switch 140 and/or the additional switch 160 may be operatively connected to the control unit (not shown), which may be configured to selectively control the operation of the switch(es) based on a current state or demanded state of the energy storage system. In one example, the switch 40 may be closed to allow the resistor circuit 130 to discharge the energy storage module 110 for maintenance purposes. In that case energy stored in the energy storage module 110 may be dissipated over the resistor circuit 130 instead of being discharged into the grid. The switch 130 may also be used for discharging the energy storage module 110 during steady state operation of the energy storage system, thereby allowing for energy to be balanced between different modules of the system.

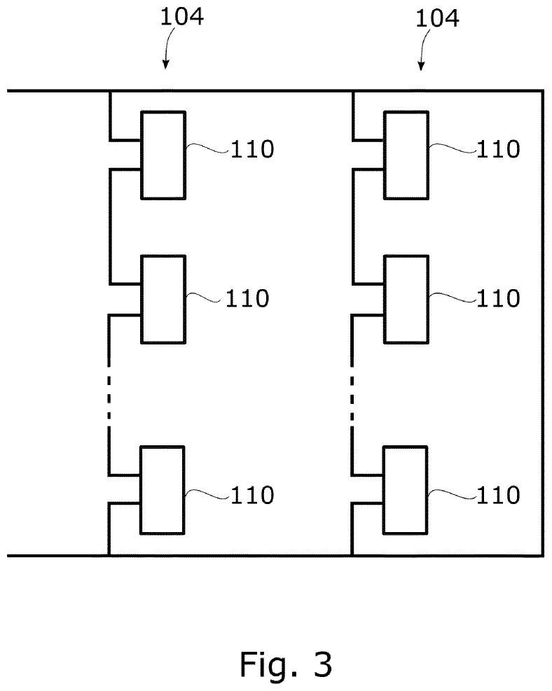

FIG. 3 shows a configuration in which a plurality of energy storage strings 104, comprising series-connected energy storage modules 110, are connected in parallel to a switch-controlled resistor circuit 130. The energy storage modules 110, the resistor circuit 130 and the switch 140 may be similar to the ones discussed in connection with the previous figures, with the difference that the resistor circuit 130 is common to a plurality of energy storage modules 110 arranged in at least two parallel strings 104.

It will be realised that further configurations are conceivable in which one or several energy storage modules 110 are connected in parallel and/or series to each other and to one or more resistor circuits 130 and switches 140.

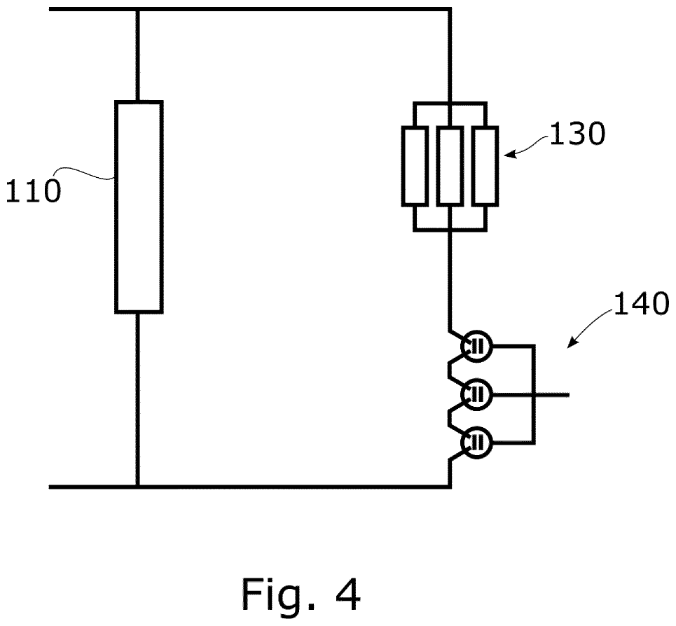

In one example shown in FIG. 4, an energy storage module 110 may be connected in parallel to a plurality of resistor circuits 130, in the present example three. As indicated in the figure, the resistor circuits 130 may be connected in parallel to each other so as to increase the power burning capacity, and further connected in series with three switches 140 that are arranged in series with each other in order to increase their capability of handling higher voltage levels. The switches 140 may for example comprise MOSFET devices controlled by the control unit.

The energy storage module 110 and the resistor circuit 130 may according to some embodiments be structurally arranged in a common physical entity, such as for example a common enclosure. Thus, it should be understood that the resistor circuit 130 may be arranged physically close to, or even be structurally integrated in the energy storage module 110.

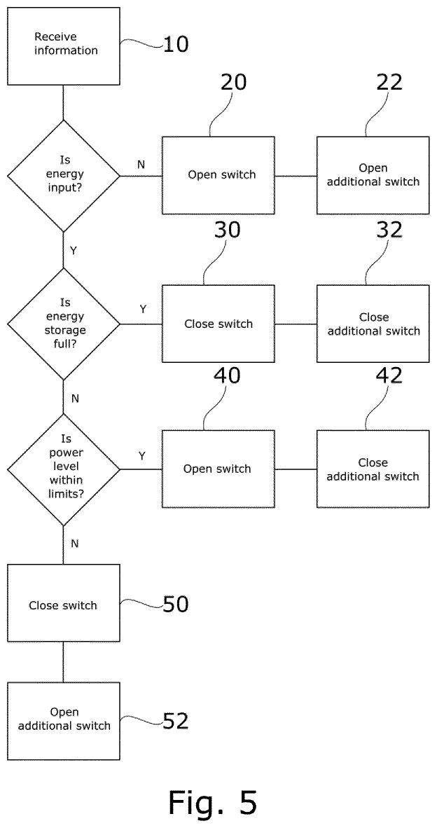

FIG. 5 illustrates a method for controlling an energy storage system which may comprise an energy storage module 110, a resistor circuit 130 and a switch 140 according to some embodiments of the present invention. The energy storage system may be similarly configured as any of the embodiments discussed above in connection with FIGS. 1-5. In some embodiments, the energy storage system may further comprise an additional switch 160, or disconnector 160, connected in series with the energy storage module 110 and operable to disconnect the energy storage module 110 from the power converter. The disconnector 160 may be connected to and controlled by the control unit 150.

The method may comprise receiving 10, by the control unit 150, information pertaining to a transmission of energy in the energy storage system 100. The information may for example indicate a level of the power transmitted to an energy storage module 110 of the system, a level of energy charged in the energy storage module 110, or an energy storage capacity of the module 110. The information may include parameters such as voltage or current of the electric energy delivered to the energy storage module 110 and/or the resistor circuit 130, and a charge/discharge rate capability of the energy storage module 110. Further, the information may indicate whether energy is charged to the energy storage module 110 or discharged by the energy storage module 110.

In case the received information indicates that energy is (or is intended to be) output from the energy storage module 110, i.e. that the energy storage module 110 is discharging energy to the AC transmission system, the control unit 150 may control the switch 140 to disconnect 20 the resistor circuit 130 from the energy storage module 110. Thus, the switch 140 may be opened 20 to allow energy to flow from the energy storage module 110 to the power converter and further on to the AC transmission system, or grid.

Additionally, in case the energy storage system also comprises a disconnector 160, the control unit 150 may be configured to control the disconnector 160 to keep the energy storage module 110 connected to the power converter. Thus, by closing 22 the additional switch 160 energy that is stored in the energy storage module 110 is allowed to be discharged to the grid.

In case the received information indicates that energy is input to the energy storage module 110, i.e., that the energy storage module 110 absorbs (or is intended to absorb) energy from the grid, the control unit 150 may control the switch 140 to connect 30 the resistor circuit 130 to the energy storage module 110. In an embodiment, the switch 140 may be closed 30 in case the energy transmitted to the energy storage module 110 exceeds a predetermined power threshold, preferably to protect the energy storage module 110 from overload. In an embodiment, the switch 140 may be closed during charging in case a level of energy stored in the energy storage module 110 exceeds a predetermined storage threshold, for example indicating the energy storage module 110 is fully charged. In case the energy storage system comprises a disconnector 160, this may be opened 32 to allow the input energy to be consumed by the resistor circuit 130 and the energy storage module 110 to be protected.

In case the control unit 150 receives information indicating that the power transmitted to the energy storage module 110 is below a predetermined power threshold, e.g. indicating that the energy storage module 110 will be operated at a safe voltage or power level, and further indicating that the energy storage module 110 is not fully charged, the control unit may control the switch 140 to be opened 40 and, optionally, the disconnector 160 to be closed 42. This allows for the transmitted energy to be stored in the energy storage module 110 instead of being consumed or burned by the resistor circuit 130.

Should the information indicate that the energy storage module 110 is exposed to, or risks to be exposed to, a too high voltage that may inflict damage on the module 110, the control unit 150 may operate the switch 140 to be closed 50 to protect the energy storage module 110. Further, the control unit 110 may cause the disconnector 160 to be opened 52 to further reduce the risk of damages to the energy storage module 110.

As outlined above the method illustrated by FIG. 5 may be embodied as computer-executable instructions distributed and used in the form of a computer-program product including a computer-readable medium storing such instructions. By way of example, computer-readable media may comprise computer storage media and communication media. As is well known to a person skilled in the art, computer storage media includes both volatile and non-volatile, removable and non-removable media implemented in any method or technology for storage of information such as computer readable instructions, data structures, program modules or other data. Further, it is known to the skilled person that communication media typically embodies computer readable instructions, data structures, program modules or other data in a modulated data signal such as a carrier wave or other transport mechanism and includes any information delivery media.

1. An energy storage system configured to be connected to an alternating current (AC) power transmission system, comprising:
a plurality of interconnected energy storage cells forming an energy storage module;
a power converter connected to the energy storage module, the power converter being configured to output power from the energy storage module to the AC power transmission system and to charge the energy storage module with power from the AC power transmission system;
a resistor circuit connected in parallel to the energy storage module;
a switch connected in series with the resistor circuit and configured to disconnect the resistor circuit from the energy storage module; and
a control unit operably connected to the switch;
wherein the control unit is configured to receive information pertaining to a transmission of energy in the energy storage system and to control the switch based on said information.

2. The energy storage system according to claim 1, wherein the control unit is configured to control the switch to disconnect the resistor circuit from the energy storage module in case energy is output from the energy storage module.

3. The energy storage system according to claim 1, wherein the control unit is configured to control the switch to connect the resistor circuit to the energy storage module in case energy is transmitted to the energy storage module.

4. The energy storage system according to claim 1, wherein the control unit is configured to control the switch to connect the resistor circuit to the energy storage module in case energy transmitted to the energy storage module exceeds a predetermined power threshold.

5. The energy storage system according to claim 1, wherein the control unit is configured to control the switch to connect the resistor circuit to the energy storage module in case a level of energy stored in the energy storage module exceeds a predetermined storage threshold.

6. The energy storage system according to claim 1, further comprising an additional switch connected in series with the energy storage module and operably connected to the control unit.

7. The energy storage system according to claim 6, wherein the control unit is configured to control the additional switch to disconnect the energy storage module from the power converter in case energy is transmitted to the energy storage module and a level of energy stored in the energy storage module exceeds a predetermined storage threshold.

8. The energy storage system according to claim 1, comprising a plurality of energy storage modules, wherein the resistor circuit is connected in parallel to said plurality of energy storage modules.

9. The energy storage system according to claim 1, comprising a plurality of series connected energy storage modules forming an energy storage string, wherein the resistor circuit is connected in parallel to the energy storage string.

10. The energy storage system according to claim 1, wherein the energy storage module and the resistor circuit are structurally arranged in a common physical entity.

11. The energy storage system according claim 1, comprising a plurality of resistor circuits connected in parallel to the energy storage module.

12. A method for controlling an energy storage system that includes a plurality of interconnected energy storage cells forming an energy storage module, a power converter connected to the energy storage module, the power converter being configured to output power from the energy storage module to an alternating current (AC) power transmission system and to charge the energy storage module with power from the AC power transmission system, a resistor circuit connected in parallel to the energy storage module, a switch connected in series with the resistor circuit and configured to disconnect the resistor circuit from the energy storage module, and a control unit operably connected to the switch, the method comprising:
receiving information pertaining to a transmission of energy in the energy storage system; and
controlling the switch based on said information.

13. The method according to claim 12, further comprising:
opening the switch in case energy is output from the energy storage module; and
closing the switch in case energy transmitted to the energy storage module exceeds a predetermined power threshold.

14. The method according to claim 12, wherein the energy storage system further comprises an additional switch connected in series with the energy storage module and operably connected to the control unit, the method further comprising:
opening the additional switch in case energy is transmitted to the energy storage module and a level of energy stored in the energy storage module exceeds a predetermined storage threshold.
